(19) United States
(12) Patent Application Publication
(10) Pub. No.: US 2019/0025927 A1
(43) Pub. Date: Jan. 24, 2019

(54) DYNAMICALLY ALTERING A CONTROL ACTION THAT IS RESPONSIVE TO A USER GESTURE BASED ON EXTERNAL DATA

(71) Applicant: Lenovo Enterprise Solutions (Singapore) Pte. Ltd., Singapore (SG)

(72) Inventors: Gary D. Cudak, Wake Forest, NC (US); Michael A. Perks, Austin, TX (US); Srihari V. Angaluri, Raleigh, NC (US); Ajay Dholakia, Cary, NC (US)

(21) Appl. No.: 15/657,455

(22) Filed: Jul. 24, 2017

(51) Int. Cl. G06F 3/01; G06F 3/0488; G06K 9/00

(52) U.S. Cl. CPC G06F 3/017; G06K 9/00335; G06F 3/0488

(57) ABSTRACT

A computing device includes a processor and computer readable media storing program instructions executable by the processor to receive a user gesture through a first input device and obtain external data through a second input device. The program instructions are further executable by the processor to access a plurality of records, each record associating a control action with a combination of a user gesture definition and an external data criterion, and to identify, using the plurality of records, a control action that is associated with both a user gesture definition that is satisfied by the received user gesture and an external data criterion that is satisfied by the obtained external data. In addition, the program instructions are executable by a processor to execute the identified control action on the computing device.

### BACKGROUND

The present disclosure relates to how an electronic device responds to a user gesture.

### Background of the Related Art

A user gesture is a physical action taken by a user that initiates a control action in an electronic device. The implementation of user gestures may offer convenience to a user, requiring less of the user's time and attention to initiate a control action. Furthermore, user gestures are typically more intuitive than a text-based commands or menu structures, and their use can be learned in a shorter period of time.

A user gesture may, for example, be a pointing device gesture, touchscreen gesture, or motion gesture. A pointing device, such as a mouse, track ball or track pad gesture, enables gestures that may combine a two-dimensional movement with one or more clicks of a button. A touchscreen gesture may include a wide variety of actions and movements relative to a touchscreen. For example, one touchscreen gesture is a multi-touch gesture in which a user touches the screen in two places using two fingers, and then moves the fingers together (i.e., a “pinch gesture”) while maintaining contact with the screen in order to zoom out on a displayed image.

A motion gesture may involve either direct physical movement of a device, such as a mobile communication device, or detection of physical movement beyond the device. Direct physical movement of a device may be detected using an accelerometer. Physical movement beyond the device may be detected using a motion capture system. For example, a motion capture system may include an infrared projector and camera to identify various objects, their locations, and perhaps movement of those objects.

### BRIEF SUMMARY

One embodiment provides a computer program product comprising non-transitory computer readable storage media having program instructions embodied therewith. The program instructions are executable by a processor to receive a user gesture through a first input device of a computing device and obtain external data through a second input device of the computing device. The program instructions are further executable by the processor to access a plurality of records, each record associating a control action with a combination of a user gesture definition and an external data criterion, and to identify, using the plurality of records, a control action that is associated with both a user gesture definition that is satisfied by the received user gesture and an external data criterion that is satisfied by the obtained external data. In addition, the program instructions are executable by a processor to execute the identified control action on the computing device.

Another embodiment provides an apparatus comprising at least one storage device for storing program instructions and at least one processor for processing the program instructions. The processor may process the program instructions to receive a user gesture through a first input device of a computing device and to obtain external data through a second input device of the computing device. The processor may further process the program instructions to access a plurality of records, each record associating a control action with a combination of a user gesture definition and an external data criterion, and to identify, using the plurality of records, a control action that is associated with both a user gesture definition that is satisfied by the received user gesture and an external data criterion that is satisfied by the obtained external data. In addition, the processor may process the program instructions to execute the identified control action on the computing device.

### BRIEF DESCRIPTION OF THE SEVERAL VIEWS OF THE DRAWINGS

FIG. 1 is a diagram of a system in which a computing device may obtain external data originating outside the computing device.

FIG. 2 is a diagram of a computing device in the form of a smartphone.

FIGS. 3A-3B are examples of a dynamic gesture control table.

FIG. 4 is a flowchart of a method according to one embodiment.

### DETAILED DESCRIPTION

One embodiment provides a computer program product comprising non-transitory computer readable storage media having program instructions embodied therewith. The program instructions are executable by a processor to receive a user gesture through a first input device of a computing device and obtain external data through a second input device of the computing device. The program instructions are further executable by the processor to access a plurality of records, each record associating a control action with a combination of a user gesture definition and an external data criterion, and to identify, using the plurality of records, a control action that is associated with both a user gesture definition that is satisfied by the received user gesture and an external data criterion that is satisfied by the obtained external data. In addition, the program instructions are executable by a processor to execute the identified control action on the computing device.

Non-limiting examples of the computing device include a smartphone, gaming system, automotive computer, general purpose computing system, and any other electronic system that has one or more input device that can receive user gestures and external data. While embodiments may have greater utility and a greater variety of external data when implemented in a mobile computing device, embodiments may be implemented in a wide variety of form factors and types of computing devices, including a desktop computer, server or automotive computer.

The computing device may identify and initiate a control action based on a combination of external data and a captured gesture, and optionally further based on internal data. The association between a control action and a combination of external data and gesture that will trigger the control action may be stored in memory of the computing device. These associations may be established in various manners, such as through user configuration or a set of standard gesture settings defined by a system manufacturer, software developer, or standards setting organization. Optionally, a user may configure the associations by manually specifying a combination of external data and user gesture that should initiate any given control action. Furthermore, the user gesture may be a standard user gesture or a custom user gesture that the user enters into the system, perhaps by recording an instance of the custom user gesture.

The user gesture may include a motion gesture, a touchscreen gesture, button gesture, audio gesture, motion capture gesture, other user input, and combinations thereof. For example, a “motion gesture” involves movement of the computing device, such as a “shake”, “tap”, “twist”, “circle motion” etc of the device. Typically, a motion gesture involves movement of the entire device and is detected by an accelerometer. A “touchscreen gesture” typically involves movement of a finger or stylus on a touchscreen. A “button gesture” may include pressing a button or combination of simultaneous or sequential presses on one or more buttons. An “audio gesture” may include a voice command. Still further, a “motion capture gesture” may include motion detection via a camera or other specialized image detection device. Other types of gestures that are currently known or developed in the future may also be used.

The computing device has the ability to access external data. External data may be accessed using one or more sensors or components of the computing device, but the external data itself is obtained from sources beyond the computing device. External data may include what is sometimes referred to as ambient data. However, external data is not limited to data regarding conditions that are ever-present in the environment, but may include data or conditions that are obtained through interaction or queries with other devices.

The external data may include environmental data, such as the air temperature in the area of the computing device, a sound, or an image. Such environmental data may be directly obtained using one or more sensors that are components of the computing device, or the environmental data may be obtained through communication with one or more other devices that have or collect the data. For example, the temperature in a room where the computing device is located may be measured with a thermal or infrared sensor included within the computing device or directly coupled to the computing device. Alternatively, the outdoor temperature or weather may be obtained by communicating directly with a weather sensor external to the computing device or with a weather service over a network, such as a web server accessed via the Internet.

The external data may include the identification of nearby items or communication devices. For example, a computing device may detect and identify certain communication devices using one or more transceiver, such as a transceiver compatible with near-field communication (NFC), radio frequency identification (RFID), or ultra high frequency (UHF) radio waves (such as the Bluetooth wireless standard; Bluetooth is a registered trademark of the Bluetooth Special Interest Group, Inc.). For example, the Bluetooth wireless standard includes a device discovery process that enables an initial exchange of information, such as a device address, device class, and device name. Embodiments of the computing device may use external data consisting of this basic information about a device that is within communication range of the computing device, whereas other embodiments of the computing device may use external data that includes additional information obtained via a service of the device that is discovered by the computing device. In one option, the computing device may send a query to the external communication device requesting specific external data.

The computing device may also obtain external data from another user device. For example, the external data may be the location of one or more user devices identified in a contacts list stored on the computing device. Alternatively, the external data may include a recent call record involving the other user device. Access and use of external data from another user's device may be restricted, such that it may only be possible to access the external data of a trusted user device or a user device that has granted permission, perhaps through an “opt-in” service. For example, certain mobile communication devices include a setting for location services, which allows the user of one device to share their location with the user of another device. Accordingly, a computing device may have access to the location of any number of other user devices identified in the contacts list stored by the computing device, such that the location data may be the external data that is used to dynamically select a control action that should be initiated in response to a certain gesture. In one specific example, the external data may be a notification, and the control action may include initiating communication with a contact having a profile that is the most relevant to subject matter of the notification. The relevance of a profile may be judged by an indication of some experience or other credentials associated with the notification or the subject matter of the notification.

The computing device that obtains the external data may or may not perform internal processing or analysis to determine whether the external data satisfies the external data criterion. For example, the external data may include an image obtained by a camera, wireless communication signals obtained by a transceiver, or sounds obtained by a microphone. While the computing device may include the camera, wireless transceiver and/or microphone that collects or obtains the external data, the computing device may also process the external data to make various useful determinations. For example, the computing device may include a processor and non-transitory computer readable storage media having program instructions embodied therewith, wherein the program instructions are executable by the processor to make use of the external data. Certain embodiments may include program instructions for performing image recognition on an image obtained by the camera, perform device recognition on a communication signal or data packet obtained by the wireless transceiver, or perform voice recognition on an audio sample obtained by the microphone. It should be recognized that the image recognition, device recognition, and voice recognition may be further supported by previously stored data or contact information, such as a contacts database that associates a contact (a user) with an image, a device address or other unique device identifier, or a voice sample. Similar techniques and technology may be used to identify other surrounding objects and conditions, such as audio analysis of signals received by a microphone to identify a car running, music playing, people talking, rain falling, and the like. The processing of program instructions to identify people and other objects from images, audio and signals may occur within the computing device, or the processing may occur in another device providing the processing as a service. Optionally, the computing device may collect external data and provide it to a server that performs the processing and returns information including identification of a person, object or condition identified from the external data.

Furthermore, the external data may include content from a media source, such as a news story or social media post obtained from a web server. For example, upon the computing device receiving a news story notification or upon the computing device displaying a news story in a news app, input of a particular gesture might cause the computing device to initiate a control action that initiates a message or brings up a conditional messaging screen addressed to a target contact having a profile indicating some experience or other credentials associated with the news story or the subject matter of the new story. Similarly, upon viewing a social media post on the computing device, a given gesture input to the computing device may, for example, initiate a message to a person tagged in the post that is also in the user's contacts.

Still further, the external data may include communications that have been received by the computing device from other devices, such as records of recently received calls, email messages, or text messages. For example, a computing device may associate a particular gesture with initiating a call directed to a contact who has most frequently emailed or messaged the computing device during a trailing time period, such as the last hour. Alternatively, if the most recently received notifications are not from a known contact, then the gesture might be associated with initiating a call directed to a contact who is a work-related contact or social contact having a profile that is the most relevant to the subject matter of the notification. Optionally, the selected contact record may be automatically displayed, rather than automatically initiating a message or call to the contact, in order to facilitate user review of the selected contact and confirmation that the user wants to send a message or place a call to the selected contact.

Optionally, embodiments may also use data that is internal to the computing device as a secondary basis for determining a control action that should be initiated in response to a particular gesture. For example, such internal data may include, without limitation, the identity of one or more app that is currently open, data that is stored on the computing device, or whether the computing device is in a locked or unlocked state. Accordingly, the internal data may further inform a context in which the particular gesture should be interpreted, such that the internal data may be used in combination with the external data and the particular gesture in order to determine what control action to initiate.

Although the associations between a control action and the combination of user gesture definition and external data criterion may be stored in various data structures, non-limiting examples of such associations may be described and illustrated in the context of a lookup table. In one non-limiting example of a lookup table, each row may identify a particular user gesture definition and each column may identify particular external data criterion. When a received user gesture matches the user gesture definition identified in a given row of the table and external data obtained satisfies the external data criterion with a given column of the table, then the control action identified in the cell at the intersection of the given row and given column is initiated. Accordingly, any given user gesture may initiate different control actions based upon the external data obtained at the time that the user gesture is received. In other words, a given user gesture may initiate a first control action in response to first external data (external data satisfying first predetermined external data criterion), and the same user gesture may initiate a second control action in response to second external data (external data satisfying second predetermined external data criterion).

Another embodiment provides an apparatus comprising at least one storage device for storing program instructions and at least one processor for processing the program instructions. The processor may process the program instructions to receive a user gesture through a first input device of a computing device and to obtain external data through a second input device of the computing device. The processor may further process the program instructions to access a plurality of records, each record associating a control action with a combination of a user gesture definition and an external data criterion, and to identify, using the plurality of records, a control action that is associated with both a user gesture definition that is satisfied by the received user gesture and an external data criterion that is satisfied by the obtained external data. In addition, the processor may process the program instructions to execute the identified control action on the computing device.

The foregoing apparatus or system may further process the program instructions to implement or initiate any one or more aspects of the computer program product described herein. Accordingly, a separate discussion of those program instructions are not being repeated in the context of an apparatus or system.

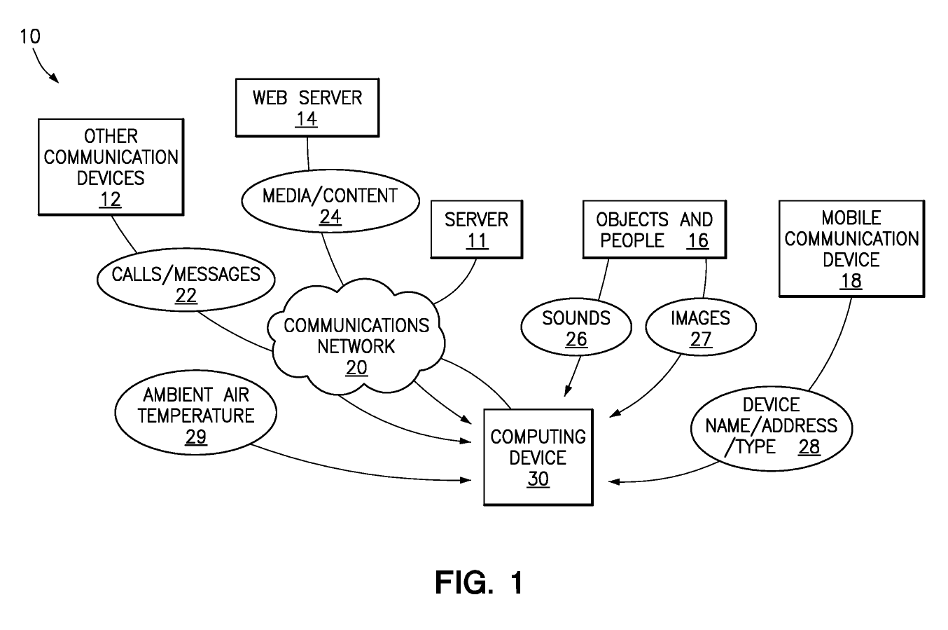

FIG. 1 is a diagram of a system 10 in which a computing device 30 may obtain external data originating outside the computing device. The system 10 in this non-limiting example illustrates various devices for implementing various embodiments, but embodiments may be implemented without including every device shown. In this example, the system 10 includes a server 11, other communication devices 12, a remote web server 14, objects and people 16, a mobile communication device 18, and a communications network 20.

The computing device 30 may use an internal sensor to obtain certain external data, such as use of a temperature sensor to obtain the ambient air temperature 29 around the computing device. Similarly, the computing device 30 may use a microphone to detect sounds 26 and images 27 from objects and people 16.

Optionally, the computing device 30 may obtain external data in the form of calls and/or message 22 from the other communication devices 12 via the communications network 20. In a similar option, the computing device 30 may obtain external data in the form of media and content 24 from the web server 14 via the communications network 20. Still further, the computing device 30 may obtain external data in the form a device name, device address or device type from the mobile communication device 18.

Embodiments of the computing device 30 may also obtain similar or dissimilar external data from a server 11, but the server 11 may also provide services to the computing device 30, such as processing of program instructions to determine whether the external data satisfies the external data criterion in one or more record of a dynamic gesture control table.

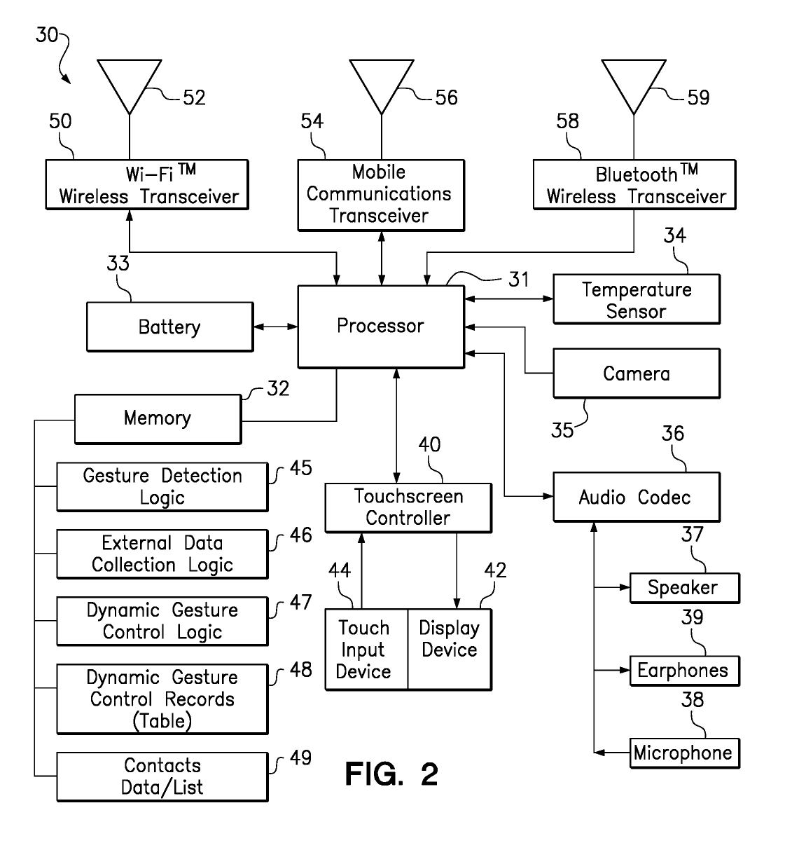

FIG. 2 is a diagram of a computing device in the form of a smartphone 30 capable of implementing various disclosed embodiments. The smartphone 30 may include a processor 31, memory 32, a battery 33, a temperature sensor 34, a camera 35, and an audio codec 36 coupled to a built-in speaker 37, a microphone 38, and an earphone jack 39. The smartphone 10 may further include a touchscreen controller 40 which provides a graphical output to the display device 42 and an input from a touch input device 44. Collectively, the display device 42 and touch input device 44 may be referred to as a touchscreen. The touchscreen may be in either a locked condition or an unlocked condition. The touchscreen is fully functional in the unlocked condition, but, when the touchscreen is in the locked condition, the touch input device 44 will ignore all attempted input other than a specific unlocking gesture.

The smartphone 30 may also include a Wi-Fi™ wireless transceiver 50 and corresponding antenna 52, a cellular communications transceiver 54 and corresponding antenna 56, and a Bluetooth™ wireless transceiver 58 and corresponding antenna 59. Accordingly, the Bluetooth™ wireless transceiver 58 may, for example, enable communication between the smartphone 30 and the mobile communication device 18 (See FIG. 1). Similarly, the cellular communications transceiver 54 may be used to enable communication between the smartphone 30 and other communication devices 12, and the Wi-Fi™ wireless transceiver 50 may be used to enable communication with the web server 14.

In order to implement one or more embodiments, the memory 32 may include user gesture detection logic 45, external data collection logic 46, dynamic gesture control logic 47, dynamic gesture control records (table) 48, and contacts data or list 49. For example, the gesture detection logic 45 may be used to monitor input one or more input device of the computing device and identify a user gesture that has been received. The external data collection logic 46 may be responsible for monitoring external data as it is obtained and perhaps also for querying one or more sources for additional external data to determine an appropriate control action for any given user gesture. The dynamic gesture control logic 47 may use the user gesture received by the gesture detection logic 45, the external data obtained by the external data collection logic 46, and a dynamic gesture control records (table) 48, in order to identify and execute a control action based upon the received user gesture and the obtained external data. Certain embodiments may also use contacts data or list 49 to facilitate a control action of initiating communication with one of the contacts or identifying one of the contacts.

It should be recognized that certain program instructions may be executed by the computing device, such as the smartphone 30, and certain other program instructions may be executed by a server 11 that performs one or more aspect of the embodiments. Accordingly, each device may store that portion of the program instruction for which the respective device is responsible. For example, the server 11 may process program instructions for determining whether external data received by the computing device 30 meets the external data criterion of any of the plurality of records. Accordingly, the computing device 30 may process program instructions for sharing external data obtained by the computing device and a user gesture received by the computing device.

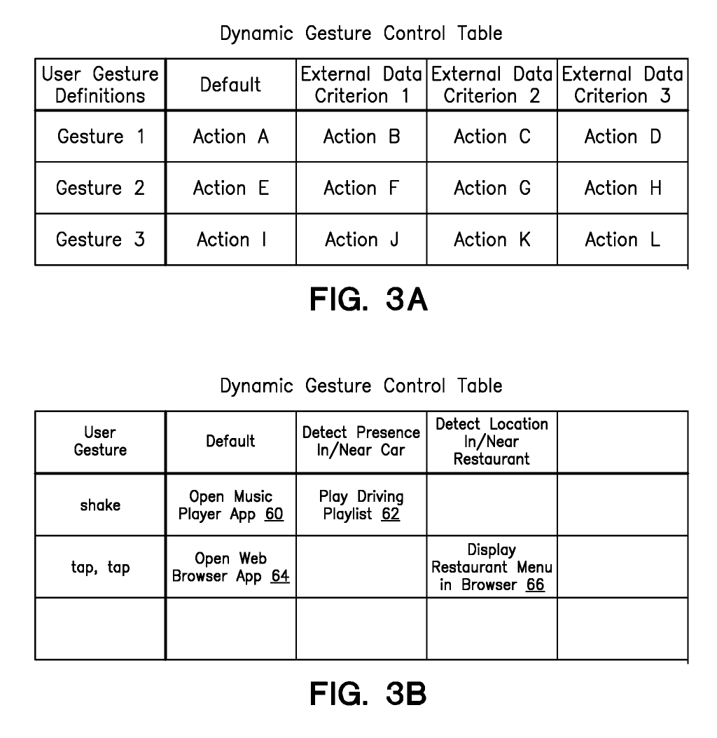

FIGS. 3A-3B are examples of a dynamic gesture control table. FIG. 3A is a generic version of a dynamic gesture control table that describes a non-limiting format that may be implemented consistent with various embodiments. In this example, a first column identifies a user gesture definition in each row (record) below the header. The header for the second and subsequent columns each identify external data criterion. Accordingly, the cells of the table below the header for the second and subsequent columns may identify a control action. When a user gesture is received that satisfies one of the user gesture definitions in a given row of the table and external data is obtained that satisfies one of the external data criterion in a given column of the table, then embodiments may execute a control action identified in the cell at the intersection of the given row and the given column. For example, a computing device that receives a user gesture satisfying the user gesture definition for Gesture 2 and obtains external data satisfying the External Data Criterion 2 would execute the Control Action G. Note that the same user gesture (satisfying the user gesture definition for Gesture 2) might trigger execution of Control Action H if the obtained external data satisfies External Data Criterion 3 instead of External Data Criterion 2. This example table includes a Default column that includes, for each user gesture definition (row), a control action that is taken in response to receiving a gesture satisfying one of the User Gesture Definitions when none of the defined External Data Criterion 1-3 are obtained.

FIG. 3B is a dynamic gesture control table following the format describe in reference to FIG. 3A and containing various specific examples of specific control actions that are associated with various combinations of a user gesture definition and external data criterion. The control action of “open music player app” 60 is executed in response to receiving a user gesture satisfying a “shake” gesture definition without external data satisfying any of the external data criterion identified in the second or subsequent column headers. Alternatively, the control action of “play driving playlist” 62 is executed in response to receiving a user gesture satisfying the same “shake” gesture definition if external data is obtained satisfying the external data criterion of “detect presence in or near a car.” Therefore, the control action that is taken in response to a “shake” gesture is dependent upon the external context of the computing device. In one option, the “shake” gesture is a motion gesture that involves the user shaking the computing device, such as a mobile communication device including an accelerometer. A “shake” gesture could also be implemented with other input devices, such as a mouse.

Similarly, the control action of “open web browser app” 64 is executed in response to receiving a user gesture satisfying a “tap, tap” gesture definition without external data satisfying any of the external data criterion identified in the second or subsequent column headers. Alternatively, the control action of “display restaurant menu in browser” 64 is executed in response to receiving a user gesture satisfying the same “tap, tap” gesture definition if external data is obtained satisfying the external data criterion of “detect location in or near a restaurant.” Therefore, the control action that is taken in response to a “tap, tap” gesture is dependent upon the external context of the computing device. A dynamic gesture control table may implement any number of user gesture definitions, any number of external data criterion, and as may control actions as there are combinations of user gesture definitions and external data criterion. In one option, the “tap, tap” gesture is a touchscreen gesture involving the user making two quick taps on a touchscreen surface. A “tap, tap” gesture could also be implemented with other input devices, such as a mouse or trackpad.

One example of a possible entry in the dynamic gesture control table might be configured for the combination of a received user gesture satisfying a “shake, twist” user gesture definition and external data satisfying an external data criterion of “member of user's contact list located at user's home” to trigger the control action of “initiate call to the member whose current location is the user's home. In this example, the external condition is the location of one or more device that is identified in the user's contacts list. The control action may include the presentation of a conditional call target on a display of the user device. Accordingly, the gesture may be used to call a contact that is at the user's home. Alternatively, the system may obtain the locations of a plurality of user devices identified in the contact list, then display a conditional call target for a contact that is currently closest to the user device. In this respect, the function could conditionally target a call to a contact that is physically the closest to the user device's current location.

Another example of a possible entry in the dynamic gesture control table might be configured for the combination of a received user gesture satisfying a “shake, shake” user gesture definition and external data satisfying an external data criterion of “member of a management group not on a phone call” to trigger the control action of “initiate a call to the member of the management group who is currently not on a phone call.” For example, a user device may establish a group of contacts, perhaps based on a common characteristic. Optionally, the group could be contacts that are members of a management team or contacts that are on vacation together. Rather that sequentially calling members of the group until reaching a contact that is not currently on a phone call, the user's computing device could obtain external data identifying which group members are or are not on a phone call, then target a call to a contact within the group that is currently not on a call.

A further example of a possible entry in the dynamic gesture control table might be configured for the combination of a received user gesture satisfying a “circle motion” user gesture definition and external data satisfying an external data criterion of “discover and identify a proximate device (i.e., an external device that is located within Bluetooth range of the computing device) of a given device type” to trigger the control action of “open a diagnostic application associated with the identified proximate device.” For example, when a user performs the circle motion gesture on their user device near an automobile, an automobile diagnostics application may be automatically opened. When a user performs the same circle motion gesture on their user device near a server, a server diagnostics application, such as Lenovo XClarity, may be automatically opened. The automobile, server or other devices may be discoverable by the user device where both devices implement the same wireless communication standard, such as the Bluetooth wireless technology standard. For example, a Bluetooth enabled device can advertise the services provided by the device, such as by using the service discovery protocol (SDP). A Bluetooth device that is in discoverable mode will share its device name, device class, list of services and other technical information. If the user's computing device is authorized, then the two devices may be paired for the computing device to perform diagnostics of the proximate device.

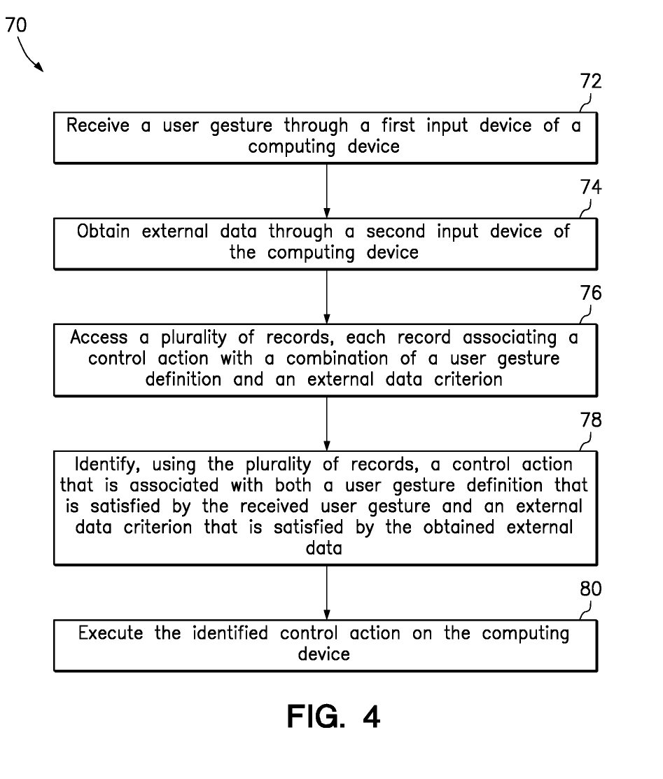

FIG. 4 is a flowchart of a method 70 according to one embodiment. In step 72, a computing device receives a user gesture through a first input device of the computing device. In step 74, the computing device obtains external data through a second input device of the computing device. In step 76, a plurality of records are accessed, each record associating a control action with a combination of a user gesture definition and an external data criterion. In step 78, the plurality of records are used to identify a control action that is associated with both a user gesture definition that is satisfied by the received user gesture and an external data criterion that is satisfied by the obtained external data. Then, in step 80, the computing device executes the identified control action.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising non-transitory computer readable storage media having program instructions embodied therewith, the program instructions executable by a processor to:
receive a user gesture through a first input device of a computing device;
obtain external data through a second input device of the computing device;
access a plurality of records, each record associating a control action with a combination of a user gesture definition and an external data criterion;
identify, using the plurality of records, a control action that is associated with both a user gesture definition that is satisfied by the received user gesture and an external data criterion that is satisfied by the obtained external data; and
execute the identified control action on the computing device.

2. The computer program product of claim 1, wherein the computing device is a mobile communication device, and wherein the user gesture is a motion gesture involving movement of the mobile communication device.

3. The computer program product of claim 2, wherein the motion gesture is selected from the group consisting of a shake, tap, twist, circle motion and combinations thereof.

4. The computer program product of claim 1, wherein the external data is obtained by the computing device using one or more sensors or components of the computing device.

5. The computer program product of claim 4, wherein the external data is an environmental condition selected from the group consisting of an air temperature, a predetermined sound, a predetermined image, and combinations thereof.

6. The computer program product of claim 1, wherein the external data is obtained from an external communication device.

7. The computer program product of claim 6, wherein the program instructions are further executable by the processor to:
send a query to the external communication device requesting the external data.

8. The computer program product of claim 6, wherein the computing device obtains the external data from the external communication device using a wireless signal transceiver, wherein the wireless signal transceiver communicates using a signal type selected from near-field communication, radio frequency identification, and ultra high frequency radio waves.

9. The computer program product of claim 8, wherein the external data obtained from the external communication device includes a device address, class of device, and device name.

10. The computer program product of claim 8, wherein the external data obtained from the external communication device includes the location of one or more user devices identified in a contacts list stored on the computing device.

11. The computer program product of claim 10, wherein the external data is a notification, and wherein the control action includes initiating communication with a contact having a profile that is the most relevant to subject matter of the notification.

12. The computer program product of claim 1, wherein the external data is a record of recently received communications selected from the group consisting of telephone calls, email messages, text messages, and combinations thereof.

13. The computer program product of claim 12, wherein the control action includes initiating a call directed to a contact who has most frequently communicated with the computing device over a trailing time period.

14. The computer program product of claim 1, wherein the external data is obtained from a server over a network.

15. The computer program product of claim 14, wherein the external data includes media content selected from the group consisting of a news story and a social media post.

16. The computer program product of claim 15, wherein the control action brings up a conditional call to a target contact having a profile entry identifying a credential associated with the media content.

17. The computer program product of claim 1, wherein the external data includes identification of nearby items or communication devices.

18. The computer program product of claim 1, the program instructions further executable by the processor to:
perform an analysis of the external data to determine whether the external data satisfies the external data criterion, wherein the analysis is selected from the group consisting of image recognition on an image obtained by a camera of the computing device, device recognition on a communication signal or data packet obtained by a wireless receiver of the computing device, and sound recognition on an audio sample obtained by a microphone of the computing device.

19. The computer program product of claim 1, wherein the computing device is selected from a smartphone, gaming system, automotive computer and general purpose computer.

20. An apparatus, comprising:
at least one storage device for storing program instructions; and
at least one processor for processing the program instructions to:
receive a user gesture through a first input device of a computing device;
obtain external data through a second input device of the computing device;
access a plurality of records, each record associating a control action with a combination of a user gesture definition and an external data criterion;
identify, using the plurality of records, a control action that is associated with both a user gesture definition that is satisfied by the received user gesture and an external data criterion that is satisfied by the obtained external data; and
execute the identified control action on the computing device.
